(19) United States
(12) Patent Application Publication
(10) Pub. No.: US 2016/0088687 A1
(43) Pub. Date: Mar. 24, 2016

(54) FLUID HEATING DEVICE

(71) Applicant: TOKUDEN CO., LTD., Kyoto-shi (JP)

(72) Inventors: Toru Tonomura, Otsu-shi (JP); Yasuhiro Fujimoto, Kyoto-shi (JP); Masayoshi Kimura, Otsu-shi (JP)

(21) Appl. No.: 14/859,007

(22) Filed: Sep. 18, 2015

(30) Foreign Application Priority Data
Sep. 19, 2014 (JP) 2014-192019
Oct. 27, 2014 (JP) 2014-217985

(51) Int. Cl. H05B 6/10; F22B 1/28; F24H 1/16

(52) U.S. Cl. CPC H05B 6/108; F24H 1/162; F22B 1/281; F24H 2250/08

(57) ABSTRACT

An object of this invention is to detect breakage of a conductor tube before it happens and to prevent leakage of the heated fluid. More concretely, this invention is a fluid heating device that applies heat to a fluid that flows in the conductor tube of a helical shape by applying induction heat to the conductor tube and that comprises an electrical connecting member that constitutes a short circuit by electrically connecting each of required portions of the conductor tube, and a potential measuring instrument that measures a potential of the conductor tube.

### FIELD OF THE ART

This invention relates to a fluid heating device that applies heat to a fluid that flows in a conductor tube of a helical shape by applying induction heat or electrical heat to the conductor tube.

### BACKGROUND ART

A conventionally known fluid heating device is shown in the patent document 1 wherein a plurality of rounds of a helical conventional tube which form a secondary coil are electrically connected by the use of an electrical connecting member that extends in an axial direction of the helical shape by means of welding or the like so as to constitute a short circuit so that electrical reactance is reduced and heating efficiency is improved.

If induction heat is applied to the helical conductor tube, a larger electric current flows in an inner circumference side of the conductor tube with a shorter length and a lower electrical resistivity than in an outer circumference side thereof, and a temperature in the inner circumference side becomes higher than that in the outer circumference side. As a result of this, thermal expansion becomes greater in the inner circumference side of the conductor tube than in the outer circumference side so that a mutual disposition of the conductor tube changes in a direction of unwinding the helical shape of the conductor tube.

In addition, since a temperature of an exit side of the fluid becomes higher than that of an entrance side, a diameter in the exit side becomes bigger so that a shape of the helical conductor tube viewed from the front changes into a trapezoid shape.

However, if the electrical connecting member is fixed to required positions of the conductor tube similar to the conventional fluid heating device, a considerable stress is generated when the conductor tube is about to change its shape and long term use may cause an accumulation of fatigue or breakage of the electrical connecting member or at a portion where the conductor tube is fixed to the electrical connecting member.

In that case, there might be not only a drop in the heating efficiency but also a leakage of the heated fluid inside of the conductor tube because the conductor tube itself is broken due to an electric discharge by a potential caused between the connected portions.

### PRIOR ART DOCUMENTS

### Patent Document

Patent document 1: Japanese Unexamined Patent Application Publication No. 2010-71624

### DISCLOSURE OF THE INVENTION

### Problems to be Solved by the Invention

The presently claimed invention is for detecting the breakage of the conductor tube before it happens and to prevent leakage of the heated fluid.

### Means to Solve the Problems

More specifically, a fluid heating device in accordance with this invention is a fluid heating device that applies heat to a fluid that flows in a conductor tube of a helical shape by applying induction heat to the conductor tube, and is characterized by an electrical connecting member that constitutes a short circuit by electrically connecting each of required portions of the conductor tube and a potential measuring instrument that measures a potential of the conductor tube.

In accordance with this arrangement, in a case that the potential detected by the potential measuring instrument exceeds a predetermined value, it is possible to notice that something is wrong with the electrical connecting member. As a result of this, it is possible to take a suitable measure such as maintenance of the device or exchanging the device before the conductor tube is broken.

In order to conduct the maintenance more securely, in a case that the potential measured by the potential measuring instrument exceeds the predetermined value, it is preferable to further provide a notification part that notifies that the measured potential exceeds the predetermined value or a driving halt part that outputs a driving halt signal.

In order to reduce generation of stress that is a root cause of breakage of the conductor tube and to prolong the life of the device, it is preferable that the electrical connecting member is transformable in accordance with a transformation of the conductor tube resulting from a temperature change of the conductor tube.

As a preferable embodiment of the electrical connecting member, the electrical connecting member may be formed by the use of a metal mesh. In accordance with this arrangement, since the metal mesh easily transforms not only in the longitudinal direction but also in the transverse direction, it is possible to sufficiently accommodate a contingent transformation of the conductor tube.

As a further different preferable embodiment of the electrical connecting member, the electrical connecting member may be formed by the use of a metal plate whose middle area is provided with a folded portion. In accordance with this arrangement, it is easily possible not only to provide mobility but also to secure a large conduction cross-sectional area.

In a case that the conductor tube produces superheated vapor by applying heat to the fluid, since the temperature rise is great so that the conductor tube transforms largely, the effect of this invention is especially remarkable.

### Effect of the Invention

In accordance with this invention having the above-mentioned arrangement, in a case that the potential detected by the potential measuring instrument exceeds a predetermined value, it is possible to notice that something is wrong with the electrical connecting member. As a result of this, it is possible to take a suitable measure such as maintenance of the device or exchanging the device before the conductor tube is broken.

### BRIEF DESCRIPTION OF THE DRAWINGS

FIG. 1 is a front view mainly showing a conductor tube of a fluid heating device in accordance with one embodiment of this invention.

FIG. 2 is a side view mainly showing the conductor tube of this embodiment.

FIGS. 3A-3C are a front view, a bottom view, and a side view showing an electrical connecting member of this embodiment.

FIGS. 4A-4C are a front view, a bottom view, and a side view showing the electrical connecting member of another embodiment of this invention.

FIG. 5 is a front view showing a fluid heating device in accordance with a further different embodiment of this invention.

FIG. 6 is a front view showing a fluid heating device in accordance with a further different embodiment of this invention.

### BEST MODES OF EMBODYING THE INVENTION

One embodiment of a fluid heating device 100 in accordance with this invention will be explained with reference to drawings.

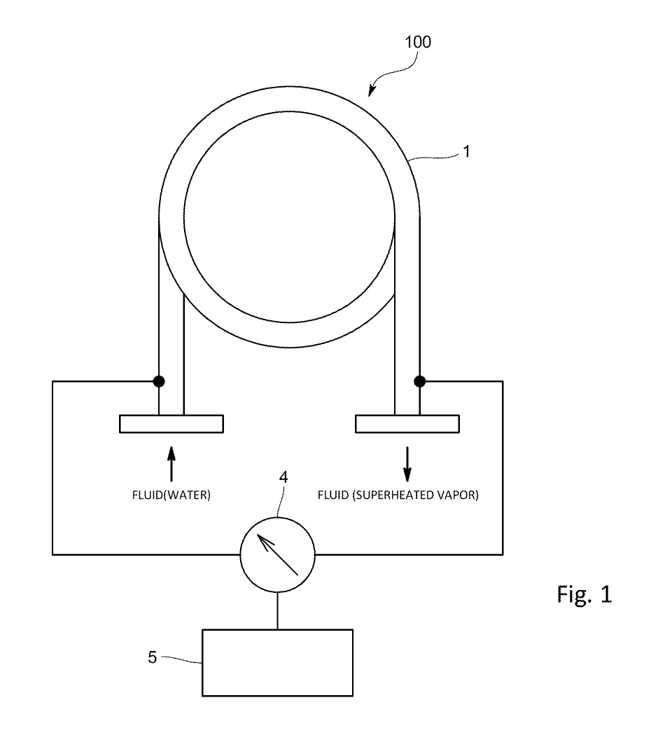

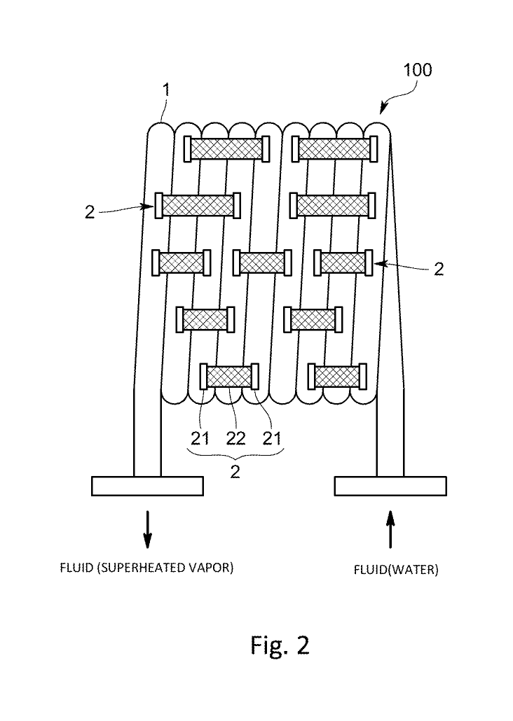

The fluid heating device 100 has a primary coil (not shown in drawings) that winds around an iron core and a secondary coil (refer to FIG. 1 and FIG. 2) comprising a helical conductor tube 1 that winds along the primary coil around an outer surface or an inner surface of the primary coil or between the primary coils, and applies heat to a fluid that circulates inside of the conductor tube 1 that constitutes the secondary coil by means of induction heating of the conductor tube 1. On one end part of the conductor tube 1 that constitutes the secondary coil is formed an introduction port to which an outer pipe to supply the secondary coil with the fluid is connected. On the other end part of the conductor tube 1 is formed a discharge port to which the outer pipe to discharge the heated fluid outside is connected.

The fluid heating device 100 applies heat to water as the fluid, and is used as a superheated vapor producing device that produces a superheated vapor whose temperature is 100° C. or more (200° C.˜2000° C.) by applying heat to the water by means of the conductor tube 1. However, the temperature to be heated or an object fluid to be heated is not limited to this. For example, the superheated vapor may be produced by applying heat to a saturated vapor produced outside by the use of the conductor tube 1.

As shown in FIG. 2, in this embodiment an electrical connecting member 2 is provided that constitutes a short circuit by electrically connecting each of the predetermined portions of the conductor tube 1.

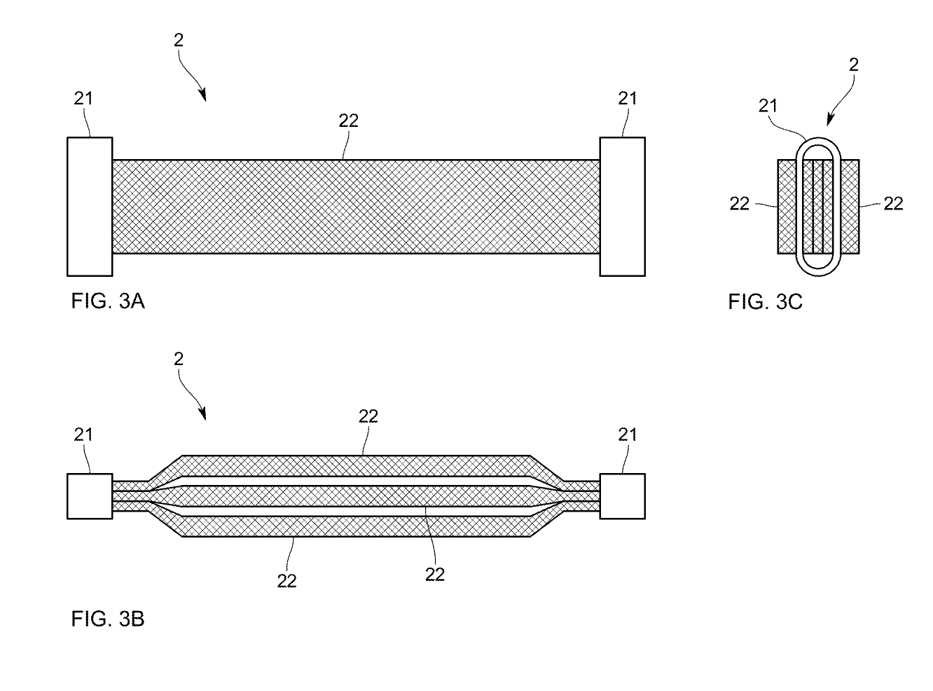

The electrical connecting member 2 is, as shown in FIGS. 3A-3C, made of a metal in an elongated shape, and comprises a pair of terminal plates for connection 21 that are both electrically and mechanically adhered to the conductor tube 1 by means of welding or brazing and a metal mesh 22 that bridges over the terminal plates for connection 21. The above-mentioned pair of the terminal plates for connection 21 are both electrically and mechanically adhered to an outer circumferential part of the secondary coil of the conductor tube 1 by means of welding or the like. In addition, the metal mesh 22 stretches in accordance with a change of a distance between the terminal plates for connection 21. In this embodiment, the metal mesh 22 is in a shape of a belt that is bent in the middle and a plurality of (three in FIGS. 3A-3C) the metal meshes 22 bridge over the terminal plates for connection 21.

A plurality of (more than three in this embodiment) the electrical connecting members 2 are mounted on a surface of the conductor tube 1 in a posture wherein an extending direction of the electrical connecting member 2 is parallel to an axial direction of the helical shape. It is preferable that a plurality of the electrical connecting members 2 are mounted separately at intervals from each other over the whole outer circumference of the secondary coil. In FIG. 2, two or three electrical connecting members 2 are mounted linearly along the axial direction of the helical shape. In addition, the terminal plate for connection 21 of each electrical connecting member 2 does not connect to an adjacent conductor tube element (a part constituting one round of the helical shape of the conductor tube 1) but is mounted on a predetermined position of a conductor tube element that is located at a position that is separated by two or more so as to electrically connect to the conductor tube elements. This is because it is difficult to connect the conductor tubes adjacent to each other in view of the space because the helical diameter of the conductor tube element is small in this embodiment. As mentioned above, the electrical connecting members 2 are mounted so as to enable a desired electrical connection by connecting the conductor tube elements that are adjacent to each other or separated to each other.

Both heat resistant and hardly oxidizable austenitic stainless steel such as SUS304 or SUS316L and INCONEL-alloy (JIS alloy number NCF601 or the like) are suitable as a material of the terminal plate for connection 21 or the metal mesh 22.

Furthermore, as shown in FIG. 1, provided in this embodiment are a potential measuring instrument (a voltmeter) 4 that measures a potential between an inlet of the conductor tube 1 and an outlet thereof (more accurately, a potential between any two points locating in an end part side from an area where the electrical connecting member 2 is arranged on the conductor tube 1) and a monitor device 5 that has a notification part that issues a warning when a potential measured by the potential measuring instrument 4 exceeds a predetermined value and/or a driving halt part that outputs a driving halt signal. The potential measuring instrument 4 in this embodiment is so connected as to measure the electrical potential between an introducing port of the conductor tube 1 or an adjacent portion thereof and a discharging port of the conductor tube 1 or an adjacent portion thereof.

For example, if a number of turns of the input winding for induction heating is N and an applied voltage to the input winding is E, an electric voltage between an entrance and an exit of the fluid as being a beginning and an end of the conductor tube 1 is E/N in a state that the conductor tube 1 is in a complete short circuit. Considering a case that a part of the electrical connecting member 2 is broken and out of place, an electric voltage of 2E/N is generated between the beginning and the end of the conductor tube 1.

In this embodiment, since the change of the electric potential can be notified by issuing the alarm or outputting the driving halt signal so as to inform necessity of repair, it is possible to prevent breakage of the conductor tube 1 itself before it happens.

Furthermore, in accordance with this arrangement, since the electrical connecting member 2 transforms in accordance with a transformation of the conductor tube 1 resulting from the temperature change of the conductor tube 1, there is no chance of generating considerable stress for the conductor tube 1 or the electrical connecting member 2 itself or at a portion where the conductor tube 1 is fixed to the electrical connecting member 2 and it is possible to prevent accumulation of fatigue, resulting in prevention of breakage as much as possible. As a result of this, it becomes possible to elongate a repair cycle and a life of the device.

In addition, since the electrical connecting member 2 is made of the metal mesh 22 that is easily transformable not only in the longitudinal direction but also in the transverse direction, it becomes possible to sufficiently accommodate contingent transformation of the conductor tube 1.

Especially, since the heating temperature to produce the superheated vapor is high so that the conductor tube 1 transforms largely in this embodiment, the above-mentioned effect is especially remarkable.

This invention is not limited to the above-mentioned embodiment.

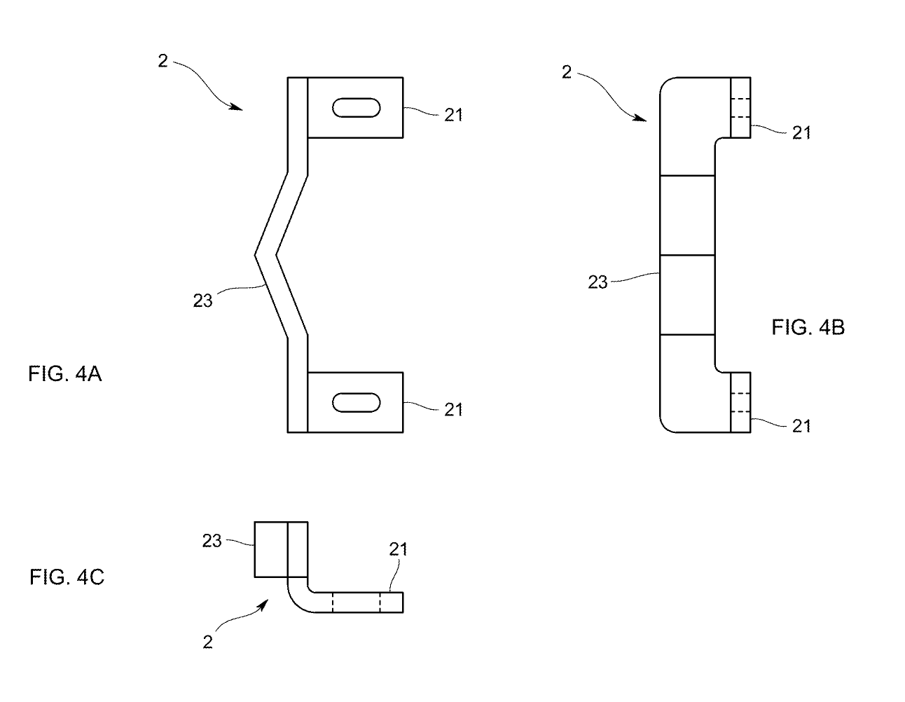

For example, the electrical connecting member 2 may be formed, as shown in FIGS. 4A-4C, by the use of a metal plate 23 with which a folded portion is provided between the terminal plates for connections 21. As the metal plate 23 with which the folded portion is provided, a metal plate may be provided with a bent portion or a curved portion. In accordance with this arrangement, it is possible to both give transformability to the metal plate and secure a large cross-sectional area of conductivity. It is preferable that a material of the metal plate 23 is the same as that of the above-mentioned metal mesh.

In addition, it is preferable that a cross-sectional area and a number of connections of the electrical connecting members are set based on a value of an electric current that flows in the electrical connecting member for every portion where the electrical connecting member is mounted. The electric current value that flows in each of the electrical connecting member largely differs depending on a state of a magnetic coupling with an input side winding or due to a difference of impedance. If the cross-sectional area and the number of connections of the electrical connecting members are set in accordance with the electric current value, it is possible both to prevent excessive heating and to avoid selecting an excess cross-sectional area and number of connections.

Furthermore, the electrical connecting member in the above-mentioned embodiment is mounted in a posture with its extending direction parallel to the axial direction of the helical shape, in other words along the axial direction of the helical shape. However, the electrical connecting member may be mounted in a posture with its extending direction displaced from the axial direction of the helical shape. For example, the electrical connecting member may be mounted in a posture with its extending direction leaning from the axial direction of the helical shape within ±45 degrees (more preferably within ±10 degrees).

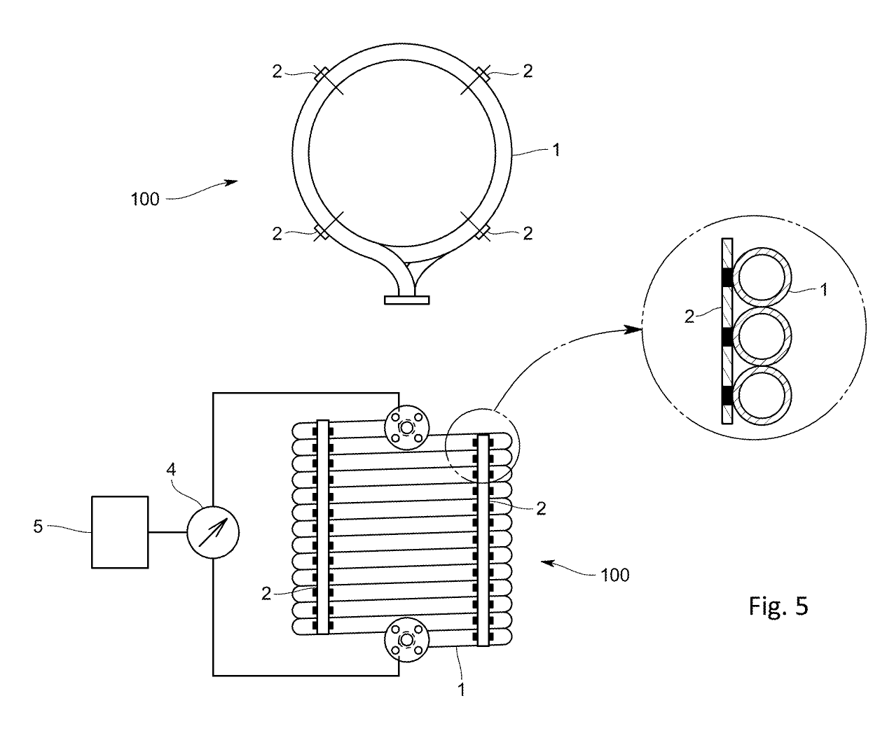

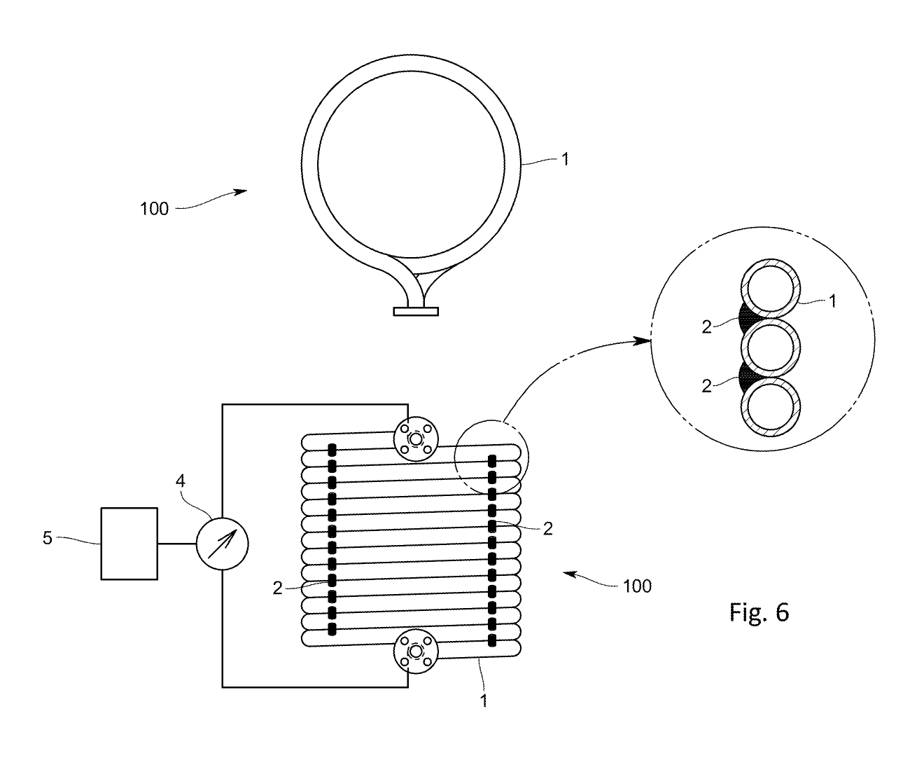

In addition, the electrical connecting member 2 is not only sufficiently transformable but also may be a metal plate 2 of a welding part 2 that connects each of the conductor tubes I as shown in FIG. 5 and FIG. 6.

The electrical connecting member 2 shown in FIG. 5 is arranged from one end to the other end along the axial direction of the helical shape on the outer circumference of the helical conductor tube 1. In addition, the electrical connecting member 2 is arranged at each of four portions separated by the same distance each other in a circumferential direction of the helical conductor tube 1. Each electrical connecting member 2 is fixed to all of the conductor tube elements from one end to the other end in the axial direction of the helical shape by means of welding or brazing. In accordance with this arrangement, the conductor tube 1 that winds in the helical shape is in a complete short circuit state wherein all of the conductor tube elements are short-circuited.

The electrical connecting member 2 shown in FIG. 6 consists of a welding part or a brazing part that connects the conductor tube elements each of which is adjacent. The welding part or the brazing part is formed along the axial direction of the helical shape in the outer circumference of the conductor tube 1 that winds in the helical shape. In addition, the welding part or the brazing part is arranged at each of four portions separated by the same distance from each other in a circumferential direction of the helical conductor tube 1. The welding part or the brazing part is formed between one end and the other end in the axial direction of the helical shape over all of the conductor tube element. In accordance with this arrangement, the conductor tube 1 that winds in the helical shape is in a complete short circuit state wherein all of the conductor tube elements are short-circuited.

In addition, it is a matter of course that the present claimed invention is not limited to the above-mentioned embodiment and may be variously modified without departing from a spirit of this invention.

### EXPLANATION OF REFERENCE CHARACTERS

100 . . . fluid heating device
1 . . . conductor tube
2 . . . electrical connecting member
5 . . . alarm device (notification part)
5 . . . alarm device (driving halt part)

1. A fluid heating device that applies heat to a fluid that flows in a conductor tube of a helical shape by applying induction heat to the conductor tube, the fluid heating device comprising:
an electrical connecting member that constitutes a short circuit by electrically connecting each of required portions of the conductor tube; and
a potential measuring instrument that measures a potential of the conductor tube.

2. The fluid heating device described in claim 1, further comprising:
a notification part that notifies that the potential measured by the potential measuring instrument exceeds a predetermined value; or
a driving halt part that outputs a driving halt signal in a case that the measured potential exceeds the predetermined value.

3. The fluid heating device described in claim 1, wherein
the electrical connecting member is transformable in accordance with a transformation of the conductor tube resulting from a temperature change of the conductor tube.

4. The fluid heating device described in claim 1, wherein
the conductor tube generates superheated vapor by applying heat to the fluid.
